(19) United States
(12) Patent Application Publication
(10) Pub. No.: US 2026/0089522 A1
(43) Pub. Date: Mar. 26, 2026

(54) Facilitating Joint Monitoring via Multi-Access Point Coordination

(71) Applicant: Cisco Technology, Inc., San Jose, CA (US)

(72) Inventors: Jerome Henry, Pittsboro, MD (US); Laurent Alexandre Pierrugues, San Jose, CA (US); Vishal S. Desai, San Jose, CA (US)

(21) Appl. No.: 18/892,063

(22) Filed: Sep. 20, 2024

(51) Int. Cl. H04W 24/08; H04W 74/04; H04W 84/12

(52) U.S. Cl. CPC H04W 24/08; H04W 74/04; H04W 84/12

(57) ABSTRACT

Devices, systems, methods, and processes for facilitating joint monitoring via multi-access point coordination. Access Points (APs) are equipped with a monitor radio in addition to service radios. The monitor radios support monitoring of channel conditions for efficient radio resource management. However, due to proximity of other radios in the same AP limits monitoring operations. To address these issues, a joint monitoring operation in multi-access point coordination (MAPC) is provided. Neighboring APs may perform ranging measurements and share ranging measurement results with a coordinator. The coordinator determines pairwise RF proximity scores for the neighboring APs and selects two or more members of a joint monitoring group based on the pairwise RF proximity scores. The coordinator may determine a monitoring schedule for the joint monitoring group based on pre-negotiated transmission opportunity schedules of the two or more members. Member APs may perform coordinated monitoring based on the monitoring schedule.

The present disclosure relates to radio resource management. More particularly, the present disclosure relates to collaborative radio resource management for joint monitoring in multi-access point coordination (MAPC).

### BACKGROUND

In computer networking, a wireless Access Point (AP) allows a Wi-Fi compatible device to connect to other devices and to a wired network. The AP can be configured to operate as a standalone device and connect to a router either directly or indirectly via a wired network, or the AP can function as an integral component of the router itself. An AP may include one or more service radios (also referred to as client-serving radios). These service radios are responsible for establishing and maintaining wireless communication with client devices, facilitating data exchange and network connectivity.

Typically, modern enterprise APs include an additional radio (referred to as monitor radio or scan radio) dedicated to performing Radio Frequency (RF) accessory functions (e.g., monitoring and scanning) and other receiver (Rx) functions with the general goal of better understanding RF conditions of available channels in each frequency band. Such monitor radio may not perform data exchange with other APs or client devices. The monitor radio may be co-located with other service radios, for example, inside the AP body. Therefore, transmission from the service radios can cause aliasing problems on the monitor radio, adversely affecting the quality of measurements by the monitor radio. Aliasing problems can occur when signals from different sources become indistinguishable from each other, causing distortion and inaccuracies in signal interpretation.

Further, many applications tend to rely on monitor radios. Each of these applications may need the monitor radio to maintain minimum set of Service Level Agreements (SLAs) to achieve application specific performance and deliverables. These applications need to contend for monitor radio resources to conduct Fine Timing Measurement (FTM) ranging measurements for location applications, determine presence of non-Wi-Fi interferers, assess channel state information (CSI), or the like and to provide these measurements to radio resource management functions. However, with the proliferation of dense networks, such as Wi-Fi6, Wi-Fi7, and other upcoming technologies, monitor radio resources may become scarce, thereby affecting the monitoring functions.

### SUMMARY OF THE DISCLOSURE

Systems and methods for collaborative radio resource management for joint monitoring in multi-access point coordination (MAPC) in accordance with embodiments of the disclosure are described herein. In many embodiments, a device, comprising a processor, a network interface controller configured to provide access to a network, and a memory communicatively coupled to the processor, is provided. The memory comprises a resource management logic that is configured to select at least a first access point (AP) and a second AP as members of a joint monitoring group, and determine a monitoring schedule for the first AP and the second AP. At least one member of the joint monitoring group is scheduled to operate in a monitoring mode as per the monitoring schedule and coordinates one or more monitoring functions of the first AP and the second AP based on the monitoring schedule.

In a number of embodiments, to coordinate the one or more monitoring functions of the first AP and the second AP, the resource management logic is further configured to transmit the monitoring schedule to the first AP and the second AP.

In a variety of embodiments, the resource management logic is further configured to receive one or more ranging measurements between the first AP and the second AP, from at least one of the first AP or the second AP.

In more embodiments, the one or more ranging measurements include at least one of Received Signal Strength Indicator (RSSI) measurements, Channel State Indicator (CSI) measurements, distance measurements, or Ultra-Wideband ranging interactions.

In additional embodiments, the resource management logic is further configured to determine a plurality of pairwise Radio Frequency (RF) proximity scores for the first AP and the second AP based on the one or more ranging measurements.

In further embodiments, the resource management logic is further configured to compare the plurality of pairwise RF proximity scores with a proximity threshold, and wherein the resource management logic selects the first AP and the second AP as the members of the joint monitoring group based on the plurality of pairwise RF proximity scores being greater than the proximity threshold.

In still more embodiments, the proximity threshold is a configurable parameter.

In still further embodiments, the resource management logic is further configured to establish Multi-Access Point Coordination (MAPC) between a plurality of APs including at least the first AP and the second AP.

In still additional embodiments, the resource management logic selects the first AP and the second AP as the members of the joint monitoring group based on the MAPC established between the first AP and the second AP.

In yet more embodiments, the resource management logic is further configured to receive one or more transmission opportunity (TXOP) schedules from the plurality of APs and generate an aggregate TXOP schedule based on the one or more TXOP schedules. In the aggregate TXOP schedule, a duration for which at least one of the first AP or the second AP is inactive in transmission is maximized.

In still yet more embodiments, a TXOP schedule from any of the first AP or the second AP is configured to indicate one or more weighted transmission requirements and one or more weighted monitoring requirements.

In many further embodiments, the resource management logic is further configured to utilize a machine learning model to maximize the duration for which at least one of the first AP or the second AP is inactive in transmission.

In many additional embodiments, the resource management logic determines the monitoring schedule for the first AP and the second AP based on the aggregate TXOP schedule.

In still yet further embodiments, at least one of the first AP or the second AP that is inactive in transmission as per the aggregate TXOP schedule is scheduled to operate in the monitoring mode based on the monitoring schedule.

In still yet additional embodiments, the resource management logic is further configured to transmit the aggregate TXOP schedule to the plurality of APs.

In several embodiments, the monitoring schedule is configured to indicate a target channel and a target monitoring duration allocated to each of the first AP and the second AP.

In several more embodiments, coordinating the one or more monitoring functions of the first AP and the second AP comprises coordinating the first AP and the second AP to at least one of monitoring different channels, monitoring same channel from different views, or jointly monitoring a wide channel.

In numerous embodiments, a device comprising a processor, a network interface controller configured to provide access to a network, and a memory communicatively coupled to the processor, is provided. The memory comprises a resource management logic that is configured to transmit, to one or more neighboring Access Points (APs), an indication for operating as a coordinator for a joint monitoring group, select at least one neighboring AP among the one or more neighboring APs as a member of the joint monitoring group, and determine a monitoring schedule for the device and the at least one neighboring AP. At least one member of the joint monitoring group is scheduled to operate in a monitoring mode as per the monitoring schedule and coordinate one or more monitoring functions of the device and the at least one neighboring AP based on the monitoring schedule.

In numerous additional embodiments, the resource management logic is further configured to transmit the indication via a management frame.

In further additional embodiments, a method, comprising selecting at least a first access point (AP) and a second AP as members of a joint monitoring group, and determining a monitoring schedule for the first AP and the second AP, is provided. At least one member of the joint monitoring group is scheduled to operate in a monitoring mode as per the monitoring schedule and coordinating one or more monitoring functions of the first AP and the second AP based on the monitoring schedule.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptual network diagram of various environments in which a networking logic may operate in accordance with various embodiments of the disclosure;

FIG. 2 is a conceptual illustration of a central controller acting as an access point coordination system (APCS) for joint monitoring in accordance with various embodiments of the disclosure;

FIG. 3 is a conceptual illustration of an AP acting as a coordinator for joint monitoring operation in accordance with various embodiments of the disclosure;

FIG. 4 is a conceptual illustration depicting joint monitoring operations by member APs of a joint monitoring group in accordance with various embodiments of the disclosure;

FIG. 5 is a flowchart showing a process for a wireless network controller acting as a coordinator of a joint monitoring group in accordance with various embodiments of the disclosure;

FIG. 6 is a flowchart showing a process for a wireless network controller acting as a coordinator of a joint monitoring group in accordance with various embodiments of the disclosure;

FIG. 7 is a flowchart showing a process for an AP acting as a coordinator of a joint monitoring group in accordance with various embodiments of the disclosure; and

FIG. 8 is a conceptual block diagram of a device suitable for configuration with a security management logic in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein that provide collaborative radio resource management for joint monitoring in multi-access point coordination (MAPC). Generally, access points (APs) are equipped with at least one monitor radio, in addition to service radios, where the role of the monitor radio is to perform monitoring and scanning of available channels. The monitor radio can determine Radio Frequency (RF) conditions such as Channel State Information (CSI), presence of interference on the channel, or the like. Such monitor radios may not be involved in data exchange functions with other APs or client devices. Typically, the monitor radio is co-located with the service radios, for example, inside the AP body. Thus, transmission from the service radios may cause interference or aliasing problems on the monitor radio, thereby affecting the quality of the measurements.

In addition, various applications such as indoor navigation, location-based services, asset tracking, etc. rely on RF measurements between the APs to provide improved user experience. The monitor radios of the APs may be utilized to perform various measurements such as Received Signal Strength Indicator (RSSI), CSI, Fine Timing Measurement (FTM) ranging, or the like to determine AP-to-AP ranging. RSSI provides measurement of signal strength received from a wireless device or another AP. RSSI can help in determining optimal placement of devices such as APs, routers, etc. to ensure strong and consistent signal coverage in a particular area. Similarly, CSI provides information on how a signal has propagated from a transmitter to a receiver, including the effects of scattering, fading, power decay, etc. CSI can also be utilized to distinguish between direct path (LOS) and reflected paths (non-LOS) of the received signal. In a similar manner, FTM ranging may be utilized to measure the distance between devices accurately. FTM ranging can be utilized to enhance the accuracy of location-based services through precise measurement of the time it takes for signals to travel between devices.

With the proliferation of dense networks, such as Wi-Fi6, Wi-Fi7, or the like, monitor radio resources may become scarce. With more APs operating in dense network scenario, monitor radios may face issues such as aliasing problems and increased contention for monitor radios. This can affect the quality of signal measurements, and in turn may affect the quality-of-service (QoS) for location-based services, CSI information, or the like. Therefore, there is a need for a solution providing monitoring functions, especially in high-density networks.

To address the above issues, the present disclosure provides a joint monitoring solution in which certain neighboring APs (for example, that have established MAPC) may perform coordinated monitoring operations. In many embodiments, neighboring APs may exchange Neighbor Discovery Protocol (NDP) frames with each other. NDP may be utilized for various aspects of network operations such as discovery of other devices in the network, address autoconfiguration, and maintaining reachability information about the paths to active neighbors. In a number of embodiments, a first AP may utilize one or more NDP frames to discover neighboring APs. Once the first AP receives the information regarding the neighboring APs, the first AP may perform ranging measurements to determine proximity with the neighboring APs. In more embodiments, the ranging measurements can be initiated by any of the neighboring APs with the first AP or with any other AP from among the neighboring APs.

In more embodiments, the ranging measurements, such as the RSSI values, CSI, FTM ranging measurements, or the like may be shared with a central controller, such as an AP coordinator system (APCS), Wireless Network Controller (WNC), or the like. In additional embodiments, the central controller may utilize one or more ranging measurements (for example, one or more of the received the RSSI values, CSI, FTM ranging measurements, etc.) to determine pairwise distances between the first AP and the neighboring APs and in turn determine a plurality of pairwise RF proximity scores (also referred to as RF proximity coefficients “RFPCs”) for the first AP and the neighboring APs. An RFPC may be utilized to determine how close two APs are from an RF environmental standpoint. For example, two APs that are close to each other and within the line of sight of each other, may have a higher RFPC as compared to two other APs that are farther apart or are separated by some obstacle, such as a wall. The ranging measurements may also be utilized to deduce a presence of obstacles between two APs.

In further embodiments, the APCS may select two or more APs, among the first AP and the neighboring APs, as members of a joint monitoring group based on the plurality of pairwise RF proximity scores. For example, the APCS may determine whether the RF proximity score of a pair of APs is above a threshold score and may accordingly select those two APs as members of the joint monitoring group. In still more embodiments, the two or more APs in the joint monitoring group may also be a part of an MAPC set and may exchange MAPC messages with each other and the APCS to make decisions regarding sharing of time, frequency, and spatial resources. For example, APs in the MAPC set, including the two or more APs of the joint monitoring group, may transmit intended transmission opportunity (TXOP) schedules to the APCS. In certain embodiments, the TXOP schedules may indicate weighted transmission requirements along with weighted monitoring requirements. Weights can be assigned to the transmission requirements and the monitoring requirements based on priority level.

Based on the received TXOP schedules, the APCS may be configured to generate an aggregate TXOP schedule. In the aggregate TXOP schedule, a duration for which at least one of the two or more APs of the joint monitoring group is inactive in transmission is maximized. In other words, in the aggregate TXOP schedule, resource units (e.g., spatial resources and time-frequency resources) are assigned to the transmission requirements of the members of the joint monitoring group in a manner that at any given time instance at least one member AP of the joint monitoring group remains inactive in transmission, and other members of the joint monitoring group remain active in transmission as per requirement. In still further embodiments, the TXOP schedules and the aggregate TXOP schedule can be generated by utilizing a machine learning model. In other words, the machine learning model may be utilized to maximize the duration for which at least one member AP of the joint monitoring group remains inactive in transmission.

In still additional embodiments, the APCS may be further configured determine a monitoring schedule for the joint monitoring group and coordinate monitoring functions of the two or more APs in the joint monitoring group based on the monitoring schedule. In various embodiments, the monitoring schedule for the two or more APs in the joint monitoring group may be determined based on the aggregate TXOP schedule. As per the monitoring schedule, at least one member AP of the joint monitoring group operates in a monitoring mode at any given time instance while other members are active in transmission. Thus, as soon as the monitoring member becomes active in transmission, another member AP of the joint monitoring group becomes inactive in transmission and active in monitoring. Consequently, the two or more APs in the joint monitoring group take turns in performing the monitoring functions, based on the monitoring schedule, and achieve interrupted monitoring. In several embodiments, the APCS may be further configured to transmit the aggregate TXOP schedule and the monitoring schedule to the two or more APs in the joint monitoring group.

In several more embodiments, coordinating the monitoring functions of the two or more APs in the joint monitoring group may include coordinating target channels and duration for monitoring. For example, monitoring APs of the joint monitoring group may tune their monitor radios to scan those frequency channels that are currently being utilized by transmitting APs of the joint monitoring group. In other words, the monitoring schedule may prioritize channel scanning as per transmission activities of the transmitting APs of the joint monitoring group. In several additional embodiments, if two member APs of the joint monitoring group simultaneously operate in the monitoring mode as per the monitoring schedule, coordinating the monitoring functions of the two member APs may include coordinating the two member APs to monitor different channels, monitor the same channel from different views, jointly monitor a wide channel, or the like.

In numerous embodiments, instead of a central controller serving as the APCS to coordinate joint monitoring operations, a participating AP can also serve as the APCS. For example, the AP serving as the APCS can transmit, to one or more neighboring APs, an indication of operating as a coordinator for the joint monitoring group. Accordingly, the coordinator AP may select at least one neighboring AP among the one or more neighboring APs as a co-member of the joint monitoring group. The at least one neighboring AP can be selected as the co-member based on an RF proximity score between the coordinator AP and the at least one neighboring AP. Further, the coordinator AP may determine a monitoring schedule for the coordinator AP and the at least one neighboring AP. In the monitoring schedule, at least one member of the joint monitoring group operates in the monitoring mode at any given time instance. Further, the coordinator AP may coordinate the monitoring functions based on the monitoring schedule.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C #, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

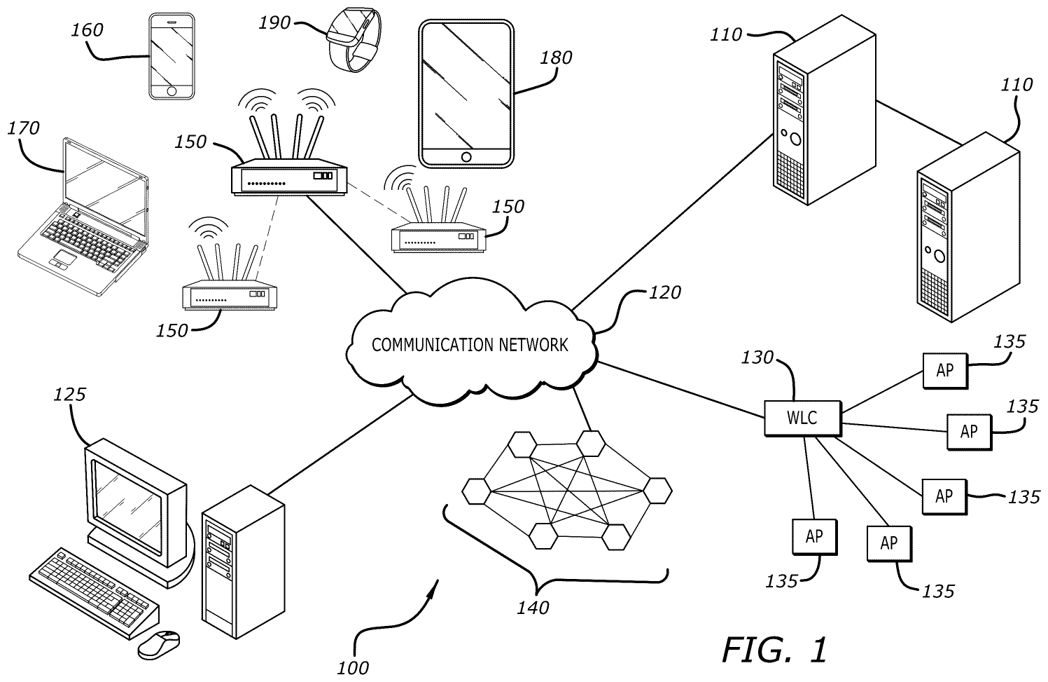

Referring to FIG. 1, a conceptual network diagram 100 of various environments in which a networking logic may operate in accordance with various embodiments of the disclosure is shown. Those skilled in the art will recognize that the networking logic can include various hardware and/or software deployments and can be configured in a variety of ways. In many embodiments, the networking logic can be configured as a standalone device, exist as a logic in another network device, be distributed among various network devices operating in tandem, or remotely operated as part of a cloud-based network management tool. In further embodiments, one or more servers 110 can be configured with the networking logic or can otherwise operate as the networking logic. In many embodiments, the networking logic may operate on one or more servers 110 connected to a communication network 120 (shown as the “Internet”). The communication network 120 can include wired networks or wireless networks. The networking logic can be provided as a cloud-based service that can service remote networks, such as, but not limited to a deployed network 140.

However, in additional embodiments, the networking logic may be operated as a distributed logic across multiple network devices. In the embodiment depicted in FIG. 1, a plurality of network access points (APs) 150 can operate as the networking logic in a distributed manner or may have one specific device operate as the networking logic for all of the neighboring or sibling APs 150. The APs 150 may facilitate Wi-Fi connections for various electronic devices, such as but not limited to, mobile computing devices including laptop computers 170, cellular phones 160, portable tablet computers 180 and wearable computing devices 190.

In further embodiments, the networking logic may be integrated within another network device. In the embodiment depicted in FIG. 1, a wireless LAN controller (WLC) 130 may have an integrated networking logic that the WLC 130 can use to monitor or control power consumption of the APs 135 that the WLC 130 is connected to, either wired or wirelessly. In still more embodiments, a personal computer 125 may be utilized to access and/or manage various aspects of the networking logic, either remotely or within the network itself. In the embodiment depicted in FIG. 1, the personal computer 125 communicates over the communication network 120 and can access the networking logic of the servers 110, or the network APs 150, or the WLC 130. In still more embodiments, the WLC 130 may be capable of monitoring network traffic flowing across the network.

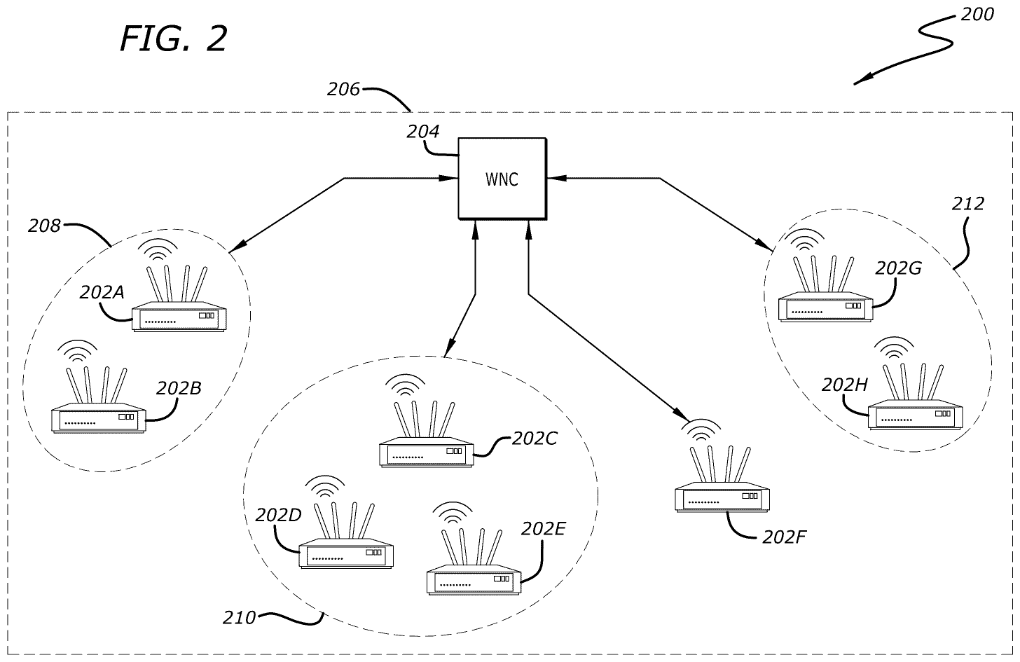

Although a specific embodiment for various environments that the networking logic may operate on a plurality of network devices suitable for carrying out the various steps, processes, methods, and operations described herein is discussed with respect to FIG. 1, any of a variety of systems and/or processes may be utilized in accordance with embodiments of the disclosure. In many non-limiting examples, the networking logic may be provided as a device or software separate from the WLC 130 or the networking logic may be integrated into the WLC 130. The elements depicted in FIG. 1 may also be interchangeable with other elements of FIGS. 2-8 and as required to realize a particularly desired embodiment.

Referring to FIG. 2, a conceptual illustration 200 of a central controller acting as an access point coordination system (APCS) for joint monitoring in accordance with various embodiments of the disclosure is shown. The embodiment shown in FIG. 2 may depict a scenario where a plurality of access points (APs) (for example, APs 202A-202H) are controlled by a wireless network controller (WNC) 204. The WNC 204 may be configured to manage, control, and optimize the performance of the APs 202A-202H located in an area 206, such as an enterprise office, university campus, technology conference, airports, or the like.

In many embodiments, the APs 202A-220H may exchange one or more Neighbor Discovery Protocol (NDP) messages to discover each other. Once an AP (for example, the AP 202A) discovers neighboring APs (such as the APs 202B-202H), the AP 202A may perform one or more ranging measurements to determine RF proximity with the APs 202B-202H. In a number of embodiments, the one or more ranging measurements may include at least one of Received Signal Strength Indicator (RSSI) measurements, Channel State Information (CSI), Fine Timing Measurement (FTM) ranging measurements, Ultra-Wideband (UWB) ranging interactions or the like to determine a distance between the AP 202A and each of the APs 202B-202H. In a variety of embodiments, the ranging measurements can be initiated by any of the APs 202A-202H, after the APs 202A-202H have discovered each other based on the NDP messages. For example, the AP 202A may measure RSSI and CSI based on an NDP message received from the AP 202B. Likewise, the AP 202A can also measure RSSIs and CSIs for other APs 202C-202H. Similarly, the APs 202B-202H can perform ranging measurements with the AP 202A. In several embodiments, the APs 202A-202H may be equipped with Ultra-Wideband (UWB) modules, where each UWB module may utilize Radio Detection and Ranging (RADAR) exchanges with neighboring APs to perform the ranging measurements.

In various embodiments, the ranging measurements may be shared with the WNC 204. The WNC 204 may operate as an AP Coordinator System (APCS). In several embodiments, the WNC 204 may utilize the received ranging measurements to determine a requirement to establish multi-access point coordination (MAPC) among the APs 202A-202H. For example, based on the received ranging measurements, the WNC 204 may determine that the APs 202A-202H are highly prone to interference due to overlapping coverage areas. In such a scenario where the WNC 204 determines such a requirement, the WNC 204 may establish MAPC among the APs 202A-202H to optimize network performance and user experience. MAPC can further enable dynamic load balancing, interference mitigation, and seamless handoff between the APs 202A-202H. In other words, the APs 202A-202H may be a part of the same MAPC set.

In numerous embodiments, the APs 202A-202H may be equipped with one or more service radios and at least one monitor radio. The service radios are responsible for establishing and maintaining wireless communication with client devices, while the monitor radio performs monitoring and scanning of available channels. For example, the monitor radio can determine RF conditions such as CSI, presence of interference on the channel, or the like. The monitor radio may not be involved in data exchange functions with other APs or client devices. Typically, the monitor radio is co-located with the service radios, for example, inside an AP body. Thus, transmission from the service radios may cause interference or aliasing problems on the monitor radio. In order to prevent such issues, the WNC 204 may be configured to provide collaborative radio resource management between two or more APs of the MAPC set for a joint monitoring operation. The following description explains how the WNC 204 provides collaborative radio resource management between two or more APs for the joint monitoring operation.

In more embodiments, the WNC 204 may utilize the received ranging measurements to determine a plurality of pairwise RF proximity scores (e.g., RF proximity coefficients “RFPCs”) for the APs 202A-202H. For example, the WNC 204 may determine a first RF proximity score for a first AP pair 202A-202B, a second RF proximity score for a second AP pair 202B-202C, a third RF proximity score for a third AP pair 202A-202D, and RF proximity scores for other AP pairs among the APs 202A-202H. It should be noted that the WNC 204 can determine RF proximity scores for all such AP pairs for which ranging measurements are received. An RF proximity score for an AP pair may be utilized as a metric to determine how proximate two APs are from an RF environmental standpoint. For example, two APs that are close to each other and within the line of sight of each other, may have a higher RF proximity score as compared to two other APs that are farther apart or are separated by some obstacle, such as a wall. The WNC 204 can utilize the ranging measurements to deduce presence of obstacles between two APs.

In still additional embodiments, the WNC 204 may compare the plurality of pairwise RF proximity scores with a proximity threshold. The proximity threshold may be a configurable or static parameter that serves as a cutoff point in determining which all APs can be grouped together for the joint monitoring operation. In an example scenario, based on the comparison of the plurality of pairwise RF proximity scores with the proximity threshold, the WNC 204 may determine that the pairwise RF proximity score of the APs 202A, 202B is greater than the proximity threshold indicating that the two APs 202A, 202B are close to each other and are within a line of sight of each other. Further, the WNC 204 may determine that the pairwise RF proximity scores of the APs 202C, 202D, 202E exceed the proximity threshold; however, the pairwise RF proximity scores of the APs 202C, 202D, 202E with any of the other APs 202A, 202B, 202F, 202G, 202H are less than the proximity threshold. This may indicate that while the APs 202C, 202D, 202E are close to each other, the APs 202C, 202D, 202E are either farther away from the other APs 202A, 202B, 202F, 202G, 202H or not within their line of sight. Likewise, the WNC 204 may determine that the pairwise RF proximity score of the APs 202G, 202H exceeds the proximity threshold and the pairwise RF proximity scores of the AP 202F with any of the other APs 202A-202E, 202G, or 202H is less than the proximity threshold, indicating that the AP 202F may not be in close proximity and line of sight of any other APs 202A-202E, 202G, or 202H.

In yet various embodiments, if the pairwise RF proximity scores of two or more APs exceed the proximity threshold, the WNC 204 may select the two or more APs as members of a joint monitoring group. In other words, the two or more APs whose pairwise RF proximity scores exceed the proximity threshold may be classified into the same joint monitoring group. Continuing the above example, the WNC 204 may select the APs 202A, 202B as members of a first joint monitoring group 208 based on the pairwise RF proximity score of the APs 202A, 202B being greater than the proximity threshold. Likewise, the WNC 204 may select the APs 202C-202E as members of a second joint monitoring group 210 and the APs 202G, 202H as members of a third joint monitoring group 212. Since the pairwise RF proximity scores of the AP 202F with any of the other APs 202A-202E, 202G, or 202H did not exceed the proximity threshold, the AP 202F may not qualify for the joint monitoring operation.

Since selection of APs in the same joint monitoring group hinges on the proximity threshold, setting the proximity threshold to a very low value can result in APs that are farther away or not in direct line of sight being grouped together for the joint monitoring operation. Conversely, setting the proximity threshold too high could prevent any two APs from being grouped together for the joint monitoring operation. Therefore, the WNC 204 may set the proximity threshold based on an effective communication range of the monitor radios of the APs 202A-202H to ensure effective collaboration for the joint monitoring operation.

In still further embodiments, the WNC 204 may receive intended transmission opportunity (TXOP) schedules of the APs 202A-202H in the MAPC set. TXOP schedules may refer to specific time periods that can be used by each of the APs for transmission without contending for the medium each time. In still more embodiments, the WNC 204 may receive an indication for one or more weighted transmission requirements or one or more weighted monitoring requirements in the received TXOP schedules from the APs 202A-202H. Weights can be assigned to the transmission requirements and the monitoring requirements based on priority level. For example, one of the APs 202B may indicate in its TXOP schedule that it is serving a high-priority traffic, such as Voice over IP (VoIP), video conferencing, online gaming, or other such low latency, high availability traffic. Thus, the AP 202B may require a larger transmission slot. The WNC 204 may generate an aggregate TXOP schedule based on the received TXOP schedules of the APs 202A-202H. In the aggregate TXOP schedule, for each joint monitoring group 208, 210, 212, a duration for which at least one member AP of corresponding joint monitoring group is inactive in transmission is maximized. In other words, in the aggregate TXOP schedule, for each joint monitoring group 208, 210, 212, resource units (e.g., spatial resources and time-frequency resources) are assigned to transmission requirements of the members of the corresponding joint monitoring group in a manner that at any given time instance at least one member AP of the joint monitoring group remains inactive in transmission, and other members of the corresponding joint monitoring group can remain active in transmission as per the requirement. For example, with respect to the first joint monitoring group 208, the aggregate TXOP schedule may maximize a duration for which at least one of the APs 202A or 202B is inactive in transmission. Likewise, with respect to the second joint monitoring group 210, the aggregate TXOP schedule may maximize a duration for which at least one of the APs 202C-202E is inactive in transmission. Further, with respect to the third joint monitoring group 212, the aggregate TXOP schedule may maximize a duration for which at least one of the APs 202G or 202H is inactive in transmission. The WNC 204 may be configured to transmit the aggregate TXOP schedule to the APs 202A-202H. For the sake of brevity, coordination of the joint monitoring operation by the WNC 204 is described with respect to the first joint monitoring group 208.

The WNC 204, in several embodiments, may determine a monitoring schedule for the first joint monitoring group 208 having the APs 202A, 202B based on the aggregate TXOP schedule. The aggregate TXOP schedule for the APs 202A, 202B may indicate time slots or time duration during which the APs 202A, 202B may be transmitting or receiving data. In numerous embodiments, the aggregate TXOP schedule may include information on channels that the APs 202A, 202B may utilize for transmission. Therefore, it becomes important for the WNC 204 to consider resources allocated to each of the APs 202A, 202B in the aggregate TXOP schedule while determining the monitoring schedule. In numerous embodiments, the monitoring schedule may be configured by a network administrator based on the aggregate TXOP schedule.

In several more embodiments, the WNC 204 may be configured to coordinate one or more monitoring functions of the APs 202A, 202B in the first joint monitoring group 208 based on the monitoring schedule. In yet more embodiments, the WNC 204 may operate at least one AP of the joint monitoring group 208 (for example AP 202A), that is inactive in transmission as per the aggregate TXOP schedule, in the monitoring mode as per the monitoring schedule. More specifically, a first member AP in the first joint monitoring group 208 that is inactive in transmission at a given time as per the aggregate TXOP schedule may be scheduled to operate in the monitoring mode at the given time in the monitoring schedule. Further, as a service radio of the first member AP starts transmitting, a second member AP in the first joint monitoring group 208 that does not have an active transmission as per the aggregate TXOP schedule, initiates the monitoring mode. Accordingly, the APs 202A, 202B in the first joint monitoring group 208 may provide an uninterrupted and collaborative monitoring operation based on the monitoring schedule. Similarly, the second and third joint monitoring groups 210, 212 may perform collaborative monitoring as per respective monitoring schedules. Thus, the WNC 204 may determine which of the first member AP or the second member AP of the joint monitoring group 208, such as APs 202A, 202B, need to operate in the monitoring mode as per the monitoring schedule and cause the monitoring AP to monitor one or more target channels for a target monitoring duration allocated in the monitoring schedule. In still yet more embodiments, the WNC 204 may utilize a machine learning model for generating the aggregate TXOP schedule. The WNC 204 may utilize the machine learning model to maximize, for each joint monitoring group, the duration for which at least one member AP is inactive in transmission.

Though in the above description selection of members of a joint monitoring group is described with respect to an MAPC set, the scope of the disclosure is not limited to it. In further additional embodiments, the members of a joint monitoring group can also be selected outside of an MAPC set.

Although a specific embodiment for a central controller acting as APCS suitable for carrying out the various steps, processes, methods, and operations described herein is discussed with respect to FIG. 2, any of a variety of systems and/or processes may be utilized in accordance with embodiments of the disclosure. For example, in numerous embodiments, the proximity threshold used for comparison with the RFPC scores may be configured by a network administrator or a machine learning model. For example, the proximity threshold may be configured based on the network traffic pattern. The elements depicted in FIG. 2 may also be interchangeable with other elements of FIGS. 1 and 3-8 as required to realize a particularly desired embodiment.

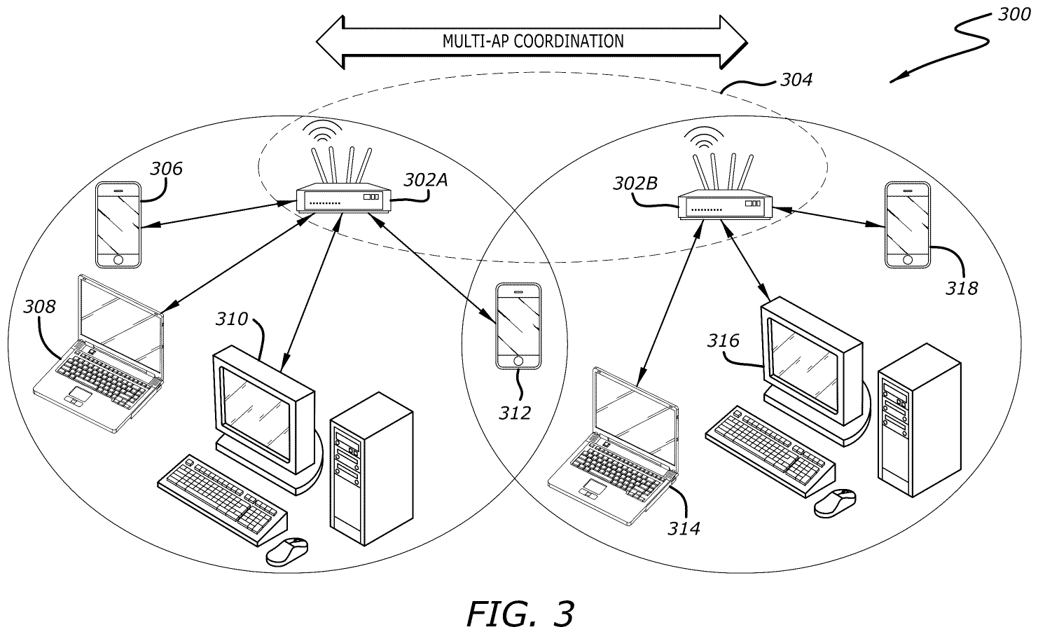

Referring to FIG. 3, a conceptual illustration 300 of an AP acting as a coordinator for joint monitoring operation in accordance with various embodiments of the disclosure is shown. The embodiment shown in FIG. 3 may depict a scenario with at least a first AP 302A and a second AP 302B deployed in a network environment 304. In many embodiments, the first AP 302A may be associated with a first set of network devices 306, 308, 310, and 312 that collectively form a first BSS. The network devices 306, 308, 310, and 312 may include smartphones, laptops, desktop computers, or the like. Similarly, the second AP 302B may be associated with a second set of network devices 314, 316, and 318 that collectively form a second BSS. An RF coverage area of the first BSS may overlap with an RF coverage area of the second BSS. In a variety of embodiments, the first and the second BSSs may form a multi-access point coordination (MAPC) set. In such a scenario, one of the first AP 302A and the second AP 302B may be selected as a coordinator. The MAPC may help optimize the network performance and user experience for the first AP 302A and the second AP 302B. MAPC can further enable dynamic load balancing, interference mitigation, and seamless handoff between the first AP 302A and the second AP 302B.

In more embodiments, one of the first AP 302A and the second AP 302B may transmit an indication to one or more neighboring APs for operating as a coordinator of a joint monitoring group. In additional embodiments, the indication to operate as the coordinator for a joint monitoring group may be included in a management frame or an augmented NDP frame. For example, the indication may be included in a modified beacon frame, a modified probe request frame, a modified association frame, or any such management frame. In another example, the augmented NDP frame may include the indication along with additional information elements (IEs) such as supported data rates, detailed data about the wireless channel conditions (CSI), FTM, or other such information required for supporting functionalities like location services, optimize network performance, and enhance security.

In an example scenario, the first AP 302A may initiate one or more ranging measurements to determine RF proximity with one or more neighboring APs (e.g., the second AP 302B). In further embodiments, the first AP 302A may utilize RSSI measurements, CSI measurements, FTM ranging measurements, or the like to determine the distance between the first AP 302A and the one or more neighboring APs, such as the second AP 302B. In still more embodiments, the ranging measurements and thereby the indication to be the coordinator of the joint monitoring group can be initiated by any of the APs, such as 302A, 302B, or one or more other neighboring APs. The one or more ranging measurements may be utilized to determine pairwise RF proximity scores between the APs 302A and 302B. In further embodiments, if the RF proximity score for a given pair of APs is higher than a proximity threshold, the first AP 302A, acting as coordinator, may select the given pair of APs as members of the joining monitoring group. The proximity threshold may be a configurable or static parameter that serves as a cutoff point in determining which all APs can be grouped together for the joint monitoring operation. For example, based on the RF proximity score, the first AP 302A may form the joint monitoring group with the second AP 302B. In other words, the first AP 302A, acting as the coordinator of the joint monitoring group, may select the second AP 302B as a co-member of the joint monitoring group based on the pairwise RF proximity score between the first AP 302A and the second AP 302B being greater than the proximity threshold.

In still more embodiments, the first AP 302A and the second AP 302B may exchange MAPC messages with each other based on the established MAPC. For example, the first AP 302A may receive an intended TXOP schedule from the second AP 302B. The first AP 302A may receive an indication for one or more weighted transmission requirements or one or more weighted monitoring requirements in the received TXOP schedules of the second AP 302B. In still further embodiments, members of the joint monitoring group, for example, the first AP 302A and the second AP 302B may negotiate the TXOP schedules to maximize a duration for which at least one of the first AP 302A or the second AP 302B is inactive in transmission. In still additional embodiments, the coordinator (for example the first AP 302A) may utilize a machine learning model to maximize the duration for which at least one of the first AP 302A or the second AP 302B is inactive in transmission. In some more embodiments, the first AP 302A may generate an aggregate TXOP schedule for the first AP 302A and the second AP 302B, such that a duration for which at least one of the first AP 302A or the second AP 302B is inactive in transmission is maximized. The first AP 302A may transmit the aggregate TXOP schedule to the second AP 302B.

In certain embodiments, the first AP 302A may be further configured to determine a monitoring schedule for the joint monitoring group (such as the first AP 302A and the second AP 302B) based on the aggregate TXOP schedule. For example, the monitoring schedule may be determined in a manner that at any given time instance at least one member AP of the joint monitoring group is scheduled to operate in the monitoring mode. In various embodiments, the at least one member AP that is scheduled to operate in the monitoring mode may be inactive in transmission as per the aggregate TXOP schedule. In other words, a member AP of the joint monitoring group that is inactive in transmission at a given time as per the aggregate TXOP schedule, may be scheduled to operate in the monitoring mode as per the monitoring schedule. In yet more embodiments, the monitoring schedule may be configured to indicate a target channel and a target monitoring duration allocated to each of the first AP 302A and the second AP 302B in the joint monitoring group. For example, the target channel for a monitoring member AP of the joint monitoring group can be the same channel at which a transmitting member AP of the joint monitoring group is transmitting. In other words, the monitoring member AP may be scheduled to scan the same channel at which the transmitting member AP is transmitting. Thus, allowing accurate measurements without aliasing.

In yet various embodiments, the first AP 302A may be configured to transmit the monitoring schedule to the second AP 302B and coordinate one or more monitoring functions of the first AP 302A and the second AP 302B as per the monitoring schedule. Coordinating the one or more monitoring functions of the first AP 302A and the second AP 302B may include organizing and synchronizing the monitoring operations of the first AP 302A and the second AP 302B based on the monitoring schedule. Further, coordinating the one or more monitoring functions of the first AP 302A and the second AP 302B may include ensuring that both the first AP 302A and the second AP 302B adhere to the monitoring schedule. For example, as the coordinator, the first AP 302A may verify a quality of measurements by monitor radios of the first AP 302A and the second AP 302B. Consequently, the first AP 302A and the second AP 302B in the joint monitoring group take turns in performing the monitoring functions, based on the monitoring schedule, and achieve interrupted monitoring.

Although a specific embodiment for an access point acting as a coordinator suitable for carrying out the various steps, processes, methods, and operations described herein is discussed with respect to FIG. 3, any of a variety of systems and/or processes may be utilized in accordance with embodiments of the disclosure. In several embodiments, more than one APs of the joint monitoring group (for example, the first AP 302A and the second AP 302B) can be inactive in transmission at the same time as per the aggregate TXOP schedule. Thus, monitor radios of both the first AP 302A and the second AP 302B can be scheduled to simultaneously operate in the monitoring mode as per the monitoring schedule. The first AP 302A and the second AP 302B may coordinate the one or more monitoring functions of the first AP 302A and the second AP 302B, such as monitoring different channels at the same time, monitoring the same channel from different views at the same time, or jointly monitor a wide channel in parts. The elements depicted in FIG. 3 may also be interchangeable with other elements of FIGS. 1-2 and 4-8 as required to realize a particularly desired embodiment.

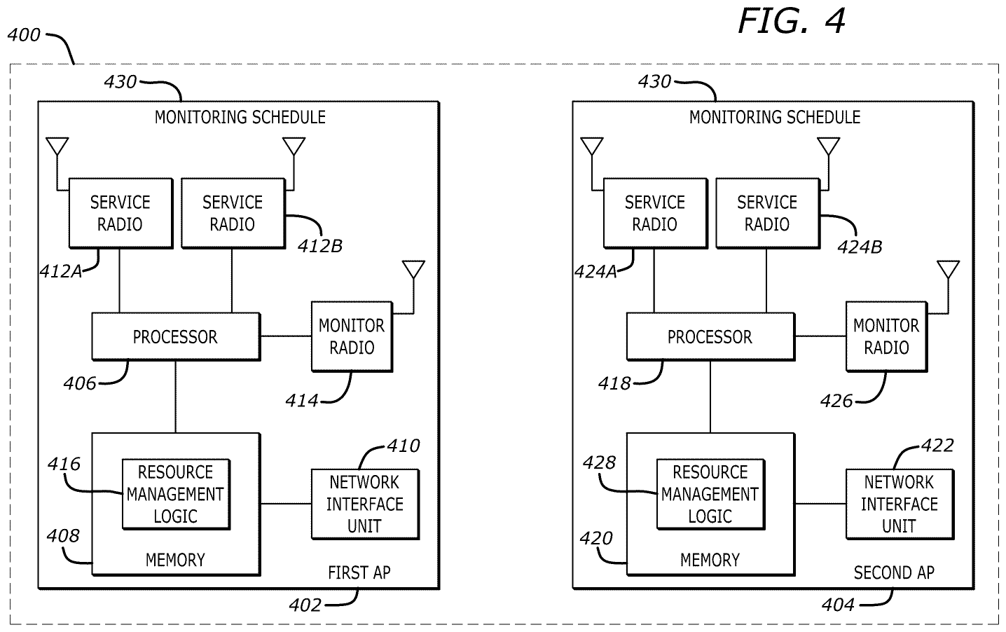

Referring to FIG. 4, a conceptual illustration 400 depicting joint monitoring operations by member APs of a joint monitoring group in accordance with various embodiments of the disclosure is shown. In many embodiments, the scenario depicted in FIG. 4 includes a first AP 402 and a second AP 404. Examples of the first AP 402 and the second AP 404 may include any networking equipment such as a router, a switch, an access point, a server, a firewall, or the like.

In a number of embodiments, the first AP 402 may include a processor 406, a memory 408, a network interface unit 410, one or more service radios 412A, 412B, and a monitor radio 414. Examples of the processor 406 may include, but are not limited to, an Application-Specific Integrated Circuit (ASIC) processor, a Reduced Instruction Set Computing (RISC) processor, a Complex Instruction Set Computing (CISC) processor, a Field-Programmable Gate Array (FPGA), a Digital Signal Processor (DSP), or the like. The memory 408 may be communicatively coupled to the processor 406 and may store various operational parameters (such as resource management logic 416, RSSI measurements, CSI measurements, FTM measurements, or the like) for determination of one or more neighboring APs, location data of APs, or the like. In a number of embodiments, the resource management logic 416 may be configured to select members of a joint monitoring group for coordinated monitoring when the first AP 402 acts as the coordinator of the joint monitoring group. The memory 408 may include any non-transitory storage device including, for example, volatile memory such as random-access memory (RAM), a read-only memory (ROM), or non-volatile memory such as EPROM, a hard disk drive (HDD), a flash memory, a solid-state memory, and the like. It will be apparent to a person skilled in the art that the scope of the disclosure is not limited to realizing the memory 408 in the first AP 402, as described herein. In a number of embodiments, the memory 408 may be realized in form of a database server or a cloud storage working in conjunction with the first AP 402, without departing from the scope of the disclosure.

In a variety of embodiments, the network interface unit 410 may be configured to provide access to the network (for example, a wireless network). The one or more service radios 412A, 412B may be configured to provide data transmission and reception functions. The monitor radio 414 may be configured to provide monitoring functions such as monitoring RF link quality, detection of obstacles between other APs or client devices, CSI measurements, or the like. Examples of the service radios 412A, 412B and the monitor radio 414 may include, but are not limited to, an antenna, a radio frequency transceiver, a wireless transceiver, a Bluetooth transceiver, an ethernet port, or any other device configured to transmit and receive data.

In more embodiments, the second AP 404 may also include a processor 418, a memory 420 communicatively coupled to the processor 418, a network interface unit 422, one or more service radios 424A, 424B, and a monitor radio 426. The memory 420 can include a resource management logic 428 that may be configured to select members of a joint monitoring group when the second AP 404 acts as the coordinator of the joint monitoring group.

In an example scenario, the first AP 402 and the second AP 404 may be selected as members of a joint monitoring group based on MAPC established between the first AP 402 and the second AP 404. Thus, the first AP 402 and the second AP 404 may receive a monitoring schedule 430 for joint monitoring operations. The monitoring schedule 430 may be determined by, for example, a WNC, an AP serving as the coordinator of the joint monitoring group, or the like. In response to receiving the monitoring schedule 430, the resource management logics 416, 428 may be configured to operate the monitor radios 414, 426 in the monitoring mode as per the monitoring schedule 430. In other words, the resource management logics 416, 428 may coordinate one or more monitoring functions of the first AP 402 and the second AP 404 as per the monitoring schedule 430.

In an example scenario, during a first time duration in the monitoring schedule 430, the first AP 402 may be designated as a monitoring AP. In such a scenario, the resource management logic 416 may be configured to operate the monitor radio 414 in the monitoring mode during the first time duration. Further, the resource management logic 416 may be configured to tune the monitor radio 414 to scan one or more frequency channels (e.g., target channels) for a target duration, the one or more frequency channels being utilized by the second AP 404 for transmission or reception during the target duration. In other words, the resource management logic 416 may synchronize the monitoring functions of the monitor radio 414 with transmission or reception functions of the second AP 404.

Further, during a second time duration in the monitoring schedule 430, the second AP 404 may be designated as a monitoring AP. In such a scenario, the resource management logic 428 may be configured to operate the monitor radio 426 in the monitoring mode during the second time duration. Further, the resource management logic 428 may be configured to tune the monitor radio 426 to scan one or more frequency channels (e.g., target channels) for a target duration, the one or more frequency channels being utilized by the first AP 402 for transmission or reception during the target duration. In other words, the resource management logic 428 may synchronize the monitoring functions of the monitor radio 426 with transmission or reception functions of the first AP 402.

Furthermore, during a third time duration in the monitoring schedule 430, the first AP 402 and the second AP 404 may be designated as monitoring APs simultaneously. In such a scenario, the resource management logics 416, 428 may be configured to operate corresponding monitor radios 414, 426 in the monitoring mode during the third time duration to perform simultaneous monitoring. Further, the resource management logics 416, 428 may be configured to coordinate the monitoring functions of the monitor radios 414, 426. In many examples, the resource management logics 416, 428 may be configured to operate corresponding monitor radios 414, 426 to monitor the same channel from different views at the same time. In many further examples, the resource management logics 416, 428 may be configured to operate corresponding monitor radios 414, 426 to monitor different channels. In many additional examples, the resource management logics 416, 428 may be configured to operate corresponding monitor radios 414, 426 to monitor the same wide channel in parts. Thus, if a target channel is 50 Gigahertz (GHz), the monitor radio 414 can monitor 25 Ghz and the other monitor radio 426 can simultaneously monitor the remaining 25 Ghz of the target channel.

Although a specific embodiment depicting joint monitoring operations by member APs of a joint monitoring group suitable for carrying out the various steps, processes, methods, and operations described herein is discussed with respect to FIG. 4, any of a variety of systems and/or processes may be utilized in accordance with embodiments of the disclosure. In still additional embodiments, the monitoring schedule 430 may include an indication for weighted monitoring requirements, such that any of the first AP 402 or the second AP 404 may indicate its monitoring requirement on a priority basis. The elements depicted in FIG. 4 may also be interchangeable with other elements of FIGS. 1-3 and 5-8 as required to realize a particularly desired embodiment.

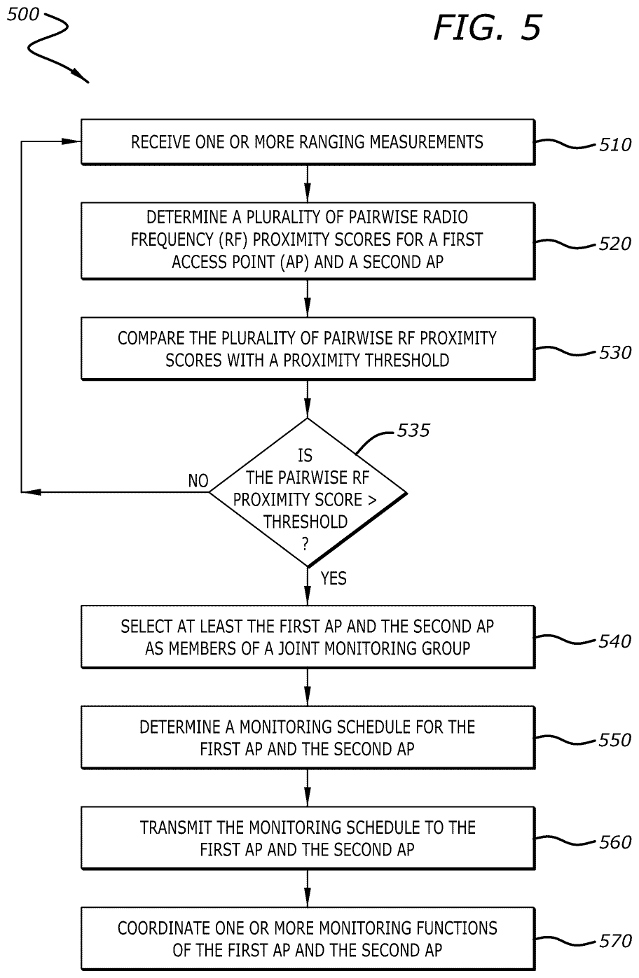

Referring to FIG. 5, a flowchart showing a process 500 for a wireless network controller acting as a coordinator of a joint monitoring group in accordance with various embodiments of the disclosure is shown. In many embodiments, the process 500 may receive one or more ranging measurements (block 510). The process 500 may receive one or more ranging measurements between a first AP and a second AP, from at least one of the first AP or the second AP. The ranging measurements may be performed by an AP to determine RF proximity with other neighboring APs. The ranging measurements may include RSSI measurements, CSI measurements, FTM ranging measurements, or the like. RSSI measurements indicate the power level of a received signal by AP. Different factors may affect an RSSI value, for example, a distance of a source device, physical barriers such as walls, furniture, etc. in between signal path, interference from other electronic devices, type and positioning of antennas of the AP. For CSI measurements, the APs may transmit known pilot signals or training sequences, process these signals after receiving to extract detailed channel information. In several embodiments, the pilot signals used for CSI measurements can be NDP frames that contain known sequences or pilot signals that enable accurate channel estimation. FTM ranging may utilize a series of timed message exchanges between two APs to calculate the distance between them by measuring round-trip time (RTT) of Wi-Fi signals between the APs. In number of embodiments, the ranging measurements may include one or more UWB radar exchanges between APs.

In a variety of embodiments, the process 500 may determine a plurality of pairwise RF proximity scores for a first AP and a second AP (block 520). The process 500 may determine the plurality of pairwise Radio Frequency (RF) proximity scores for the first AP and the second AP based on the one or more ranging measurements. For example, the process 500 may determine a plurality of RF proximity scores for the first AP with one or more neighboring APs including the second AP. Similarly, a plurality of RF proximity scores for the second AP may also be determined. An RF proximity score for two APs may be utilized to determine how close the two APs are from an RF environmental standpoint. For example, two APs that are close to each other and within the line of sight of each other, may have a higher RF proximity score as compared to two other APs that are farther apart or are separated by some obstacle, such as a wall.

In a number of embodiments, the process 500 may compare the plurality of pairwise RF proximity scores with a proximity threshold (block 530). The process 500 may select the first AP and the second AP as the members of the joint monitoring group based on the plurality of pairwise RF proximity scores being greater than the proximity threshold. The proximity threshold may be a configurable or static parameter that serves as a cutoff point in determining which all APs can be grouped together for a joint monitoring operation. The process 500 may compare the RF proximity score of the first AP and the second AP with the proximity threshold to determine whether the first AP and the second AP are close to each other, within line of sight (LOS) of each other, or may have an obstacle in between (for example, a wall). In more embodiments, the process 500 may determine whether the pairwise RF proximity score is greater than the proximity threshold (block 535).

If the pairwise RF proximity score is greater than the proximity threshold, in additional embodiments, the process 500 may select at least the first AP and the second AP as members of a joint monitoring group (block 540). The RF proximity score being greater than the proximity threshold may indicate that the first AP and the second AP are close to each other and are also within line of sight of each other. In a similar manner, the process 500 may group neighboring APs into a joint monitoring group based on the pairwise RF proximity scores of the APs. However, if it is determined that the RF proximity score is less than the proximity threshold, in numerous embodiments, the process 500 may continue with the function of receiving one or more ranging measurements (block 510).

In further embodiments, the process 500 may determine a monitoring schedule for the first AP and the second AP (block 550). The monitoring schedule may be determined in a manner that at least one member of the joint monitoring group is scheduled to operate in a monitoring mode as per the monitoring schedule at any given time instance. In other words, as per the monitoring schedule at any given time instance at least one member AP of the joint monitoring group is scheduled to be active in monitoring. In various embodiments, the process 500 may determine the monitoring schedule for the first AP and the second AP based on an aggregate TXOP schedule of the first AP and the second AP. For example, the process 500 may have established MAPC between the first AP and the second AP and may receive intended TXOP schedules from the first AP and the second AP. Based on the received TXOP schedules of the first AP and the second AP, the process 500 may generate the aggregate TXOP schedule in such a way that the duration for which at least one of the first AP or the second AP is inactive in transmission is maximized in the aggregate TXOP schedule. The time duration for which the first AP is inactive in transmission in the aggregate TXOP schedule may be set as a target monitoring duration for the first AP in the monitoring schedule. Likewise, the time duration for which the second AP is inactive in transmission in the aggregate TXOP schedule may be set as a target monitoring duration for the second AP in the monitoring schedule. Further, the process 500 may receive an indication for one or more weighted transmission requirements or one or more weighted monitoring requirements in the received TXOP schedules from the first AP or the second AP. The process 500 may, thus, generate the aggregate TXOP schedule based on the one or more weighted transmission requirements or the one or more weighted monitoring requirements.

In still further embodiments, the process 500 may transmit the monitoring schedule to the first AP and the second AP (block 560). In still additional embodiments, the process 500 may coordinate one or more monitoring functions of the first AP and the second AP (block 570). The process 500 may coordinate one or more monitoring functions of the first AP and the second AP based on the monitoring schedule. For coordinating the monitoring functions of the first AP and the second AP, the process 500 may operate at least one of the first AP or the second AP that is inactive in transmission in the monitoring mode as per the monitoring schedule.

Although a specific embodiment for a wireless network controller acting as a coordinator suitable for carrying out the various steps, processes, methods, and operations described herein is discussed with respect to FIG. 5, any of a variety of systems and/or processes may be utilized in accordance with embodiments of the disclosure. In numerous embodiments, all the APs of the joint monitoring group, for example the first AP and the second AP, may operate in transmit mode simultaneously based on the weighted transmission requirements. In such situations, measurements by a monitoring AP of the joint monitoring group may be discarded. The elements depicted in FIG. 5 may also be interchangeable with other elements of FIGS. 1-4 and 6-8 as required to realize a particularly desired embodiment.

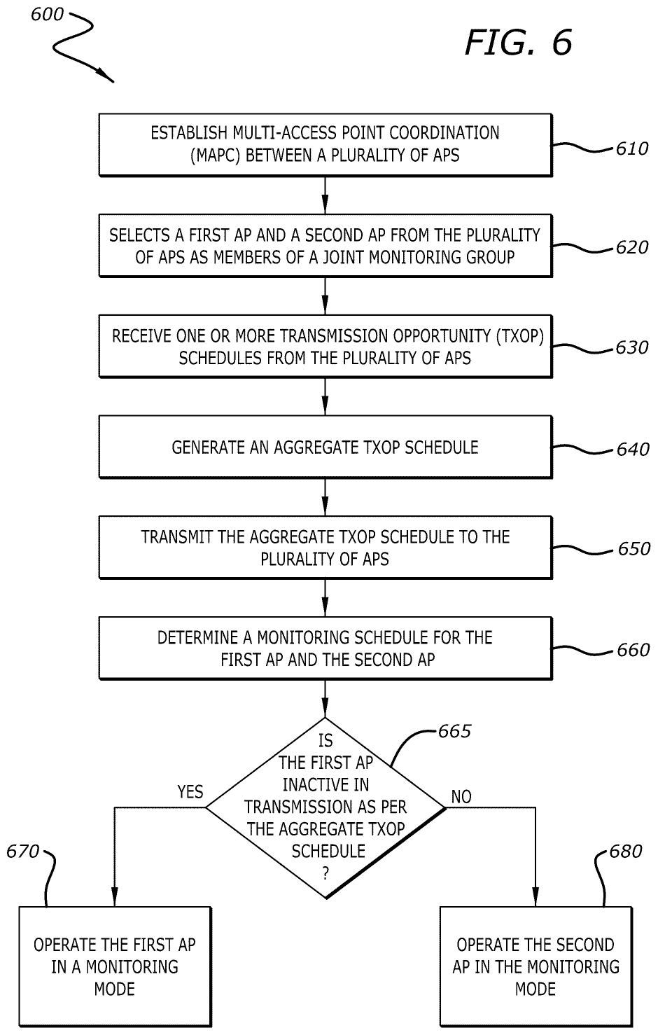

Referring to FIG. 6, a flowchart showing a process 600 for a wireless network controller acting as a coordinator of a joint monitoring group in accordance with various embodiments of the disclosure is shown. In many embodiments, the process 600 may establish MAPC between a plurality of APs (block 610). The process 600 may establish MAPC between the plurality of APs including at least a first AP and a second AP. In an example scenario, two or more APs may have an overlapping RF coverage area, thus the process 600 may establish MAPC between such APs.

In more embodiments, the process 600 may select the first AP and the second AP from the plurality of APs as members of a joint monitoring group (block 620). The process 600 may select the first AP and the second AP as the members of the joint monitoring group based on the MAPC established between the first AP and the second AP. The process 600 may determine a plurality of pairwise RF proximity scores for the plurality of APs based on ranging measurements received from the plurality of APs. The ranging measurements may include RSSI measurements, CSI measurements, FTM ranging measurements, or the like. The process 600 may select those APs (e.g., the first AP and the second AP) from the plurality of APs as members of a joint monitoring group for which the pairwise RF proximity scores are above a proximity threshold. In other words, the process 600 may group the first AP and the second AP to form the joint monitoring group based on RF proximity of the first AP and the second AP exceeding the proximity threshold.

In additional embodiments, the process 600 may receive one or more transmission opportunity (TXOP) schedules from the plurality of APs (block 630). The process 600 may receive intended TXOP schedules from the plurality of APs, including the members of the joint monitoring group, for example, the first AP and the second AP. The TXOP schedules may also indicate one or more weighted transmission requirements or one or more weighted monitoring requirements from the plurality APs.

In further embodiments, the process 600 may generate an aggregate TXOP schedule (block 640). The process 600 may generate the aggregate TXOP schedule based on the one or more TXOP schedules, wherein in the aggregate TXOP schedule, a duration for which at least one of the first AP or the second AP is inactive in transmission is maximized. In several embodiments, the process 600 may generate the aggregate TXOP schedule for the plurality APs by utilizing a machine learning model. For example, the process 600 may utilize the machine learning model to maximize the duration for which at least one of the first AP or the second AP is inactive in transmission in the aggregate TXOP schedule.

In still more embodiments, the process 600 may transmit the aggregate TXOP schedule to the plurality of APs (block 650). The process 600 may transmit the aggregate TXOP schedule to the plurality of APs, including the first AP or the second AP (e.g., members of the joint monitoring group).

In still further embodiments, the process 600 may determine a monitoring schedule for the first AP and the second AP (block 660). The process 600 may determine the monitoring schedule for the first AP and the second AP based on the aggregate TXOP schedule. The monitoring schedule may be determined in a manner that at least one member of the joint monitoring group is scheduled to operate in a monitoring mode in the monitoring schedule at any given time instance. In other words, as per the monitoring schedule at any given time instance at least one member AP of the joint monitoring group is scheduled to be active in monitoring. The monitoring schedule may be determined based on the aggregate TXOP schedule. The process 600 may coordinate one or more monitoring functions of the APs of the joint monitoring group based on the monitoring schedule.

In still additional embodiments, the process 600 may determine whether the first AP is inactive in transmission as per the aggregate TXOP schedule (block 665). The process 600 may schedule at least one of the first AP or the second AP that is inactive in transmission as per the aggregate TXOP schedule to operate in the monitoring mode based on the monitoring schedule. For example, the process 600 may determine whether the first AP is in a receive mode or idle mode. If the first AP is inactive in transmission as per the aggregate TXOP schedule, in some more embodiments, the process 600 may operate the first AP in a monitoring mode (block 670). The process 600 may operate the first AP in the monitoring mode as per the monitoring schedule.

However, if the process 600 determines the first AP to be active in transmission, in yet more embodiments, the process 600 may operate the second AP in the monitoring mode (block 680). In other words, the process 600 may coordinate the monitoring functions among APs of the joint monitoring group, such as the first AP and the second AP, based on the monitoring schedule.

Although a specific embodiment for a wireless network controller acting as a coordinator suitable for carrying out the various steps, processes, methods, and operations described herein is discussed with respect to FIG. 6, any of a variety of systems and/or processes may be utilized in accordance with embodiments of the disclosure. In numerous embodiments, one of the APs of the joint monitoring group may act as a coordinator instead of a wireless network controller. In such embodiments, the coordinator AP may be responsible for negotiating the TXOP schedules of members of the joint monitoring group and to generate the monitoring schedule. The elements depicted in FIG. 6 may also be interchangeable with other elements of FIGS. 1-5 and 7-8 as required to realize a particularly desired embodiment.

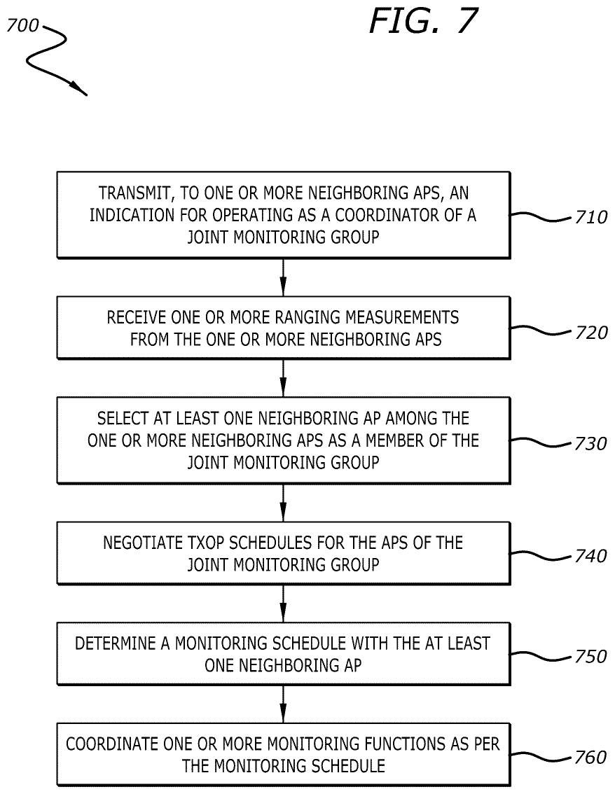

Referring to FIG. 7, a flowchart showing a process 700 for an AP acting as a coordinator of a joint monitoring group in accordance with various embodiments of the disclosure is shown. In many embodiments, the process 700 may transmit, to one or more neighboring APs, an indication for operating as a coordinator of a joint monitoring group (block 710). The process 700 may transmit the indication in the form of a management frame or an augmented NDP frame. For example, the indication may be included in a modified beacon frame, a modified probe request frame, a modified association frame, or any such management frame.

In a number of embodiments, the process 700 may receive one or more ranging measurements from the one or more neighboring APs (block 720). The process 700 may initiate one or more ranging measurements to determine RF proximity with one or more neighboring APs and may also receive ranging measurements determined by the one or more neighboring APs. The process 700 may, thus, determine and receive RSSI measurements, CSI measurements, FTM ranging measurements, or the like from the one or more neighboring APs.

In a variety of embodiments, the process 700 may select at least one neighboring AP among the one or more neighboring APs as a member of the joint monitoring group (block 730). The process 700 may utilize the one or more ranging measurements to determine an RF proximity score for each AP pair among the one or more neighboring APs and the coordinator AP. If the RF proximity score for a given pair of APs is higher than a proximity threshold, the process 700 may select the given pair of APs as members of the joint monitoring group.

In more embodiments, the process 700 may negotiate TXOP schedules for the APs of the joint monitoring group (block 740). The process 700 may negotiate the TXOP schedules of the APs of the joint monitoring group to generate an aggregate TXOP schedule. The process 700 may utilize a machine learning model to generate the aggregate TXOP schedule. The process 700 may further transmit the aggregate TXOP schedule to the APs of the joint monitoring group. In the aggregate TXOP schedule, a duration for which at least one member AP of the joint monitoring group is inactive in transmission is maximized.

In additional embodiments, the process 700 may determine a monitoring schedule with the at least one neighboring AP (block 750). The process 700 may determine a monitoring schedule with the at least one neighboring AP, such that at least one member of the joint monitoring group is scheduled to operate in a monitoring mode as per the monitoring schedule. The process 700 may determine the monitoring schedule with the at least one neighboring AP based on the aggregate TXOP schedule. For example, in the monitoring schedule, the process 700 may schedule at least one member AP of the joint monitoring group to operate in the monitoring schedule if the at least one member AP is inactive in transmission as per the aggregate TXOP schedule.

In further embodiments, the process 700 may coordinate one or more monitoring functions as per the monitoring schedule (block 760). The process 700 may coordinate one or more monitoring functions with the at least one neighboring AP based on the monitoring schedule. For example, to coordinate the one or more monitoring functions, the process 700 may transmit the monitoring schedule to the least one neighboring AP selected as a co-member of the joint monitoring group. For coordination, the process 700 may determine which member AP of the joint monitoring group needs to operate in the monitoring mode as per the monitoring schedule and cause the monitoring AP to monitor one or more target channels for a target monitoring duration allocated in the monitoring schedule.

Although a specific embodiment for access point acting as a coordinator suitable for carrying out the various steps, processes, methods, and operations described herein is discussed with respect to FIG. 7, any of a variety of systems and/or processes may be utilized in accordance with embodiments of the disclosure. In numerous embodiments, two or more APs of the joint monitoring group may be inactive in transmission at the same time. In such scenarios, these two or more APs can simultaneously coordinate to operate in the monitoring mode to at least monitor different channels, monitor same channel from different views, or jointly monitor a wide channel. The elements depicted in FIG. 7 may also be interchangeable with other elements of FIGS. 1-6 and 8 as required to realize a particularly desired embodiment.

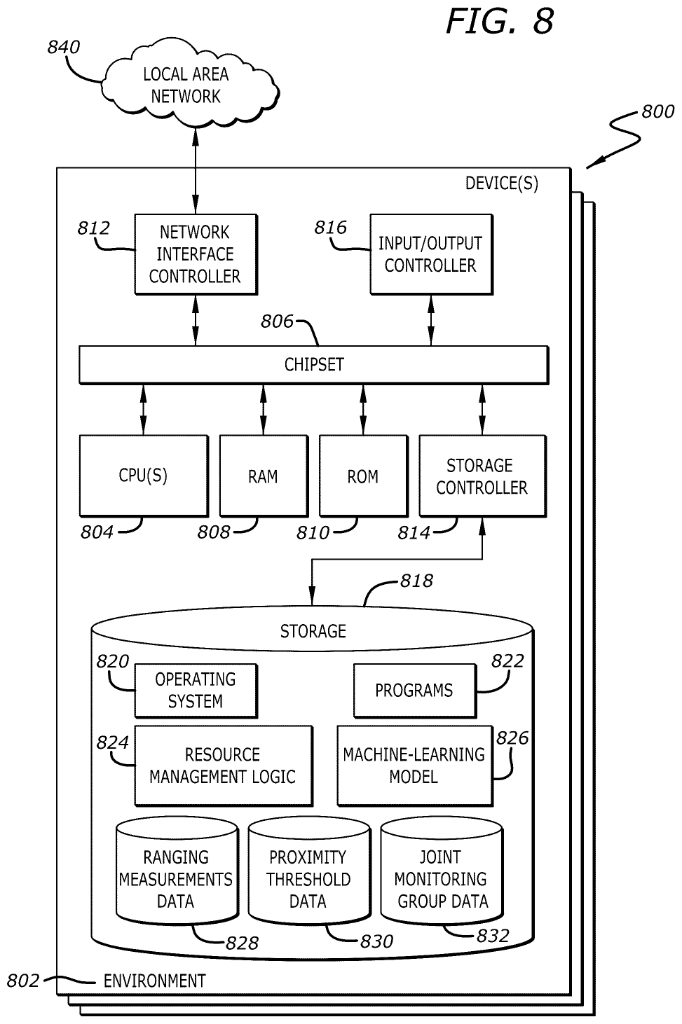

Referring to FIG. 8, a conceptual block diagram of a device 800 suitable for configuration with a security management logic in accordance with various embodiments of the disclosure is shown. The embodiment of the conceptual block diagram depicted in FIG. 8 can illustrate a conventional server, computer, workstation, desktop computer, laptop, tablet, network appliance, e-reader, smartphone, or other computing device, and can be utilized to execute any of the application and/or logic components presented herein. The embodiment of the conceptual block diagram depicted in FIG. 8 can also illustrate an access point, a switch, or a router in accordance with various embodiments of the disclosure. The device 800 may, in many nonlimiting examples, correspond to physical devices or to virtual resources described herein.

In many embodiments, the device 800 may include an environment 802 such as a baseboard or “motherboard,” in physical embodiments that can be configured as a printed circuit board with a multitude of components or devices connected by way of a system bus or other electrical communication paths. Conceptually, in virtualized embodiments, the environment 802 may be a virtual environment that encompasses and executes the remaining components and resources of the device 800. In more embodiments, one or more processors 804, such as, but not limited to, standard programmable central processing units (“CPUs”) can be configured to operate in conjunction with a chipset 806. The processor(s) 804 can be standard programmable CPUs that perform arithmetic and logical operations necessary for the operation of the device 800.

In a number of embodiments, the processor(s) 804 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 806 may provide an interface between the processor(s) 804 and the remainder of the components and devices within the environment 802. The chipset 806 can provide an interface to a random-access memory (“RAM”) 808, which can be used as the main memory in the device 800 in some embodiments. The chipset 806 can further be configured to provide an interface to a computer-readable storage medium such as a read-only memory (“ROM”) 810 or non-volatile RAM (“NVRAM”) for storing basic routines that can help with various tasks such as, but not limited to, starting up the device 800 and/or transferring information between the various components and devices. The ROM 810 or NVRAM can also store other application components necessary for the operation of the device 800 in accordance with various embodiments described herein.

Additional embodiments of the device 800 can be configured to operate in a networked environment using logical connections to remote computing devices and computer systems through a network, such as the network 840. The chipset 806 can include functionality for providing network connectivity through a network interface controller (“NIC”) 812, which may comprise a gigabit Ethernet adapter or similar component. The NIC 812 can be capable of connecting the device 800 to other devices over the network 840. It is contemplated that multiple NICs 812 may be present in the device 800, connecting the device to other types of networks and remote systems.

In further embodiments, the device 800 can be connected to a storage 818 that provides non-volatile storage for data accessible by the device 800. The storage 818 can, for instance, store an operating system 820, applications 822, ranging measurements data 828, proximity threshold data 830, and joint monitoring group data 832 which are described in greater detail below. The storage 818 can be connected to the environment 802 through a storage controller 814 connected to the chipset 806. In certain embodiments, the storage 818 can consist of one or more physical storage units. The storage controller 814 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 800 can store data within the storage 818 by transforming the physical state of the physical storage units to reflect the information being stored. The specific transformation of physical state can depend on various factors. Examples of such factors can include, but are not limited to, the technology used to implement the physical storage units, whether the storage 818 is characterized as primary or secondary storage, and the like.

In many more embodiments, the device 800 can store information within the storage 818 by issuing instructions through the storage controller 814 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 800 can further read or access information from the storage 818 by detecting the physical states or characteristics of one or more particular locations within the physical storage units.

In addition to the storage 818 described above, the device 800 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 800. In some examples, the operations performed by a cloud computing network, and or any components included therein, may be supported by one or more devices similar to device 800. Stated otherwise, some or all of the operations performed by the cloud computing network, and or any components included therein, may be performed by one or more devices 800 operating in a cloud-based arrangement.

By way of example, and not limitation, computer-readable storage media can include volatile and non-volatile, removable and non-removable media implemented in any method or technology. Computer-readable storage media includes, but is not limited to, a RAM, a ROM, electrically-erasable programmable ROM (“EEPROM”), flash memory or other solid-state memory technology, compact disc ROM (“CDROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 818 can store an operating system 820 utilized to control the operation of the device 800. According to one embodiment, the operating system 820 comprises the LINUX operating system. According to another embodiment, the operating system 820 comprises the WINDOWS® SERVER operating system from MICROSOFT Corporation of Redmond, Washington. According to further embodiments, the operating system 820 can comprise the UNIX operating system or one of its variants. It should be appreciated that other operating systems can also be utilized. The storage 818 can store other system or application programs and data utilized by the device 800.

In many additional embodiments, the storage 818 or other computer-readable storage media is encoded with computer-executable instructions which, when loaded into the device 800, may transform it from a general-purpose computing system into a special-purpose computer capable of implementing the embodiments described herein. These computer executable instructions may be stored as application 822 and transform the device 800 by specifying how the processor(s) 804 can transition between states, as described above. In some embodiments, the device 800 has access to computer-readable storage media storing computer executable instructions which, when executed by the device 800, perform the various processes described above with regard to FIGS. 1-7. In certain embodiments, the device 800 can also include computer-readable storage media having instructions stored thereupon for performing any of the other computer-implemented operations described herein.

In still further embodiments, the device 800 can also include one or more input/output controllers 816 for receiving and processing input from a number of input devices, such as a keyboard, a mouse, a touchpad, a touch screen, an electronic stylus, or other type of input device. Similarly, an input/output controller 816 can be configured to provide output to a display, such as a computer monitor, a flat panel display, a digital projector, a printer, or other type of output device. Those skilled in the art will recognize that the device 800 might not include all of the components shown in FIG. 8 and can include other components that are not explicitly shown in FIG. 8 or might utilize an architecture completely different than that shown in FIG. 8.

As described above, the device 800 may support a virtualization layer, such as one or more virtual resources executing on the device 800. In some examples, the virtualization layer may be supported by a hypervisor that provides one or more virtual machines running on the device 800 to perform functions described herein. The virtualization layer may generally support a virtual resource that performs at least a portion of the techniques described herein.

In many further embodiments, the device 800 may include a resource management logic 824. The resource management logic 824 can be configured to perform one or more of the various steps, processes, operations, and/or other methods. Often, the resource management logic 824 can be a set of instructions stored within a non-volatile memory that, when executed by the processor(s)/controller(s) 804 can carry out these steps, etc. In some embodiments, the resource management logic 824 may be a client application that resides on a network-connected device, such as, but not limited to, a server, switch, personal or mobile computing device in a single or distributed arrangement.

In various embodiments, the resource management logic 824 can be configured to perform one or more of the various steps, processes, operations, and/or other methods described above in conjunction with FIGS. 1-7 and can be configured to determine a joint monitoring group including two or more neighboring APs whose RF proximity exceed a proximity threshold. The joint monitoring group may be determined to facilitate collaborative radio resource management among member APs of the joint monitoring group. The resource management logic 824, in several embodiments, may receive TXOP schedules from a plurality of APs in the network. The resource management logic 824 may determine a monitoring schedule for a first AP and a second AP that are members of the joint monitoring group, such that at any given time instance at least one member AP is scheduled to operate in a monitoring mode as per the monitoring schedule. The resource management logic 824 may further coordinate the monitoring functions of the first AP and the second AP in accordance with the monitoring schedule, so that uninterrupted monitoring operation can be performed.

In still more embodiments, the ranging measurements data 828 may include data regarding RF measurements between APs. For example, the ranging measurements data 828 may include RSSI, CSI measurements, FTM ranging, or the like to determine AP-to-AP ranging. The ranging measurements data 828 may be utilized to determine proximity between two neighboring APs. The ranging measurements data 828 may be utilized to determine a pairwise RF proximity score for neighboring APs to indicate how proximate two APs are from an RF environmental standpoint. For example, two APs that are close to each other and within the line of sight of each other, may have a higher RF proximity score as compared to two other APs that are farther apart or are separated by some obstacle, such as a wall.

In still further embodiments, the proximity threshold data 830 may include a configurable or static parameter that serves as a cutoff point in determining which all APs can be grouped together for the joint monitoring operation. The pairwise RF proximity score determined for each AP pair may be compared with the proximity threshold data 830 to determine whether two APs can be selected as members for a joint monitoring group or not.

In still additional embodiments, the joint monitoring group data 832 may store information (e.g., identifiers, properties, etc.) regarding which AP pairs that are grouped together to perform joint monitoring operations. The resource management logic 824 may select those APs whose pairwise RF proximity scores are greater than the proximity threshold for the joint monitoring operations. Upon selection, the resource management logic 824 may update the joint monitoring group data 832 to include the information regarding the selected APs.

Finally, in numerous additional embodiments, data may be processed into a format usable by a machine-learning model 826 (e.g., feature vectors), and or other pre-processing techniques. The machine-learning (“ML”) model 826 may be any type of ML model, such as supervised models, reinforcement models, and/or unsupervised models. The ML model 826 may include one or more of linear regression models, logistic regression models, decision trees, Naïve Bayes models, neural networks, k-means cluster models, random forest models, and/or other types of ML models 826. In numerous embodiments, the ML model(s) 826 can be utilized to generate aggregate TXOP schedules based on received TXOP schedules from a plurality of APs in the network. The ML model(s) 826 may predict a monitoring schedule based on received TXOP schedules and past TXOP schedules of the plurality of APs. The ML model(s) 826 may thus generate a monitoring schedule for the first AP and the second AP, selected as part of a joint monitoring group from the plurality of APs, and coordinate the one or more monitoring functions of the first AP and the second AP.

The ML model(s) 826 can be configured to generate inferences to make predictions or draw conclusions from data. An inference can be considered the output of a process of applying a model to new data. This can occur by learning from at least the ranging measurements data 828, the proximity threshold data 830 and the joint monitoring group data 832 and use that learning to predict future outcomes. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 826 may be generated by human/administrator verifications or may compare predicted outcomes with actual outcomes.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor;
a network interface controller configured to provide access to a network; and
a memory communicatively coupled to the processor, wherein the memory comprises a resource management logic that is configured to:
select at least a first access point (AP) and a second AP as members of a joint monitoring group;
determine a monitoring schedule for the first AP and the second AP, wherein at least one member of the joint monitoring group is scheduled to operate in a monitoring mode as per the monitoring schedule; and
coordinate one or more monitoring functions of the first AP and the second AP based on the monitoring schedule.

2. The device of claim 1, wherein to coordinate the one or more monitoring functions of the first AP and the second AP, the resource management logic is further configured to transmit the monitoring schedule to the first AP and the second AP.

3. The device of claim 1, wherein the resource management logic is further configured to receive one or more ranging measurements between the first AP and the second AP, from at least one of the first AP or the second AP.

4. The device of claim 3, wherein the one or more ranging measurements include at least one of: Received Signal Strength Indicator (RSSI) measurements, Channel State Indicator (CSI) measurements, distance measurements, or Ultra-Wideband ranging interactions.

5. The device of claim 3, wherein the resource management logic is further configured to determine a plurality of pairwise Radio Frequency (RF) proximity scores for the first AP and the second AP based on the one or more ranging measurements.

6. The device of claim 5, wherein the resource management logic is further configured to compare the plurality of pairwise RF proximity scores with a proximity threshold, and wherein the resource management logic selects the first AP and the second AP as the members of the joint monitoring group based on the plurality of pairwise RF proximity scores being greater than the proximity threshold.

7. The device of claim 6, wherein the proximity threshold is a configurable parameter.

8. The device of claim 1, wherein the resource management logic is further configured to establish Multi-Access Point Coordination (MAPC) between a plurality of APs including at least the first AP and the second AP.

9. The device of claim 8, wherein the resource management logic selects the first AP and the second AP as the members of the joint monitoring group based on the MAPC established between the first AP and the second AP.

10. The device of claim 9, wherein the resource management logic is further configured to:
receive one or more transmission opportunity (TXOP) schedules from the plurality of APs; and
generate an aggregate TXOP schedule based on the one or more TXOP schedules, wherein in the aggregate TXOP schedule, a duration for which at least one of the first AP or the second AP is inactive in transmission is maximized.

11. The device of claim 10, wherein a TXOP schedule from any of the first AP or the second AP is configured to indicate one or more weighted transmission requirements and one or more weighted monitoring requirements.

12. The device of claim 10, wherein the resource management logic is further configured to utilize a machine learning model to maximize the duration for which at least one of the first AP or the second AP is inactive in transmission.

13. The device of claim 10, wherein the resource management logic determines the monitoring schedule for the first AP and the second AP based on the aggregate TXOP schedule.

14. The device of claim 13, wherein at least one of the first AP or the second AP that is inactive in transmission as per the aggregate TXOP schedule is scheduled to operate in the monitoring mode based on the monitoring schedule.

15. The device of claim 10, wherein the resource management logic is further configured to transmit the aggregate TXOP schedule to the plurality of APs.

16. The device of claim 1, wherein the monitoring schedule is configured to indicate a target channel and a target monitoring duration allocated to each of the first AP and the second AP.

17. The device of claim 1, wherein coordinating the one or more monitoring functions of the first AP and the second AP comprises coordinating the first AP and the second AP to at least one of:
monitor different channels, monitor same channel from different views, or jointly monitor a wide channel.

18. A device comprising:
a processor;
a network interface controller configured to provide access to a network; and
a memory communicatively coupled to the processor, wherein the memory comprises a resource management logic that is configured to:
transmit, to one or more neighboring Access Points (APs), an indication for operating as a coordinator for a joint monitoring group;
select at least one neighboring AP among the one or more neighboring APs as a member of the joint monitoring group;
determine a monitoring schedule for the device and the at least one neighboring AP, wherein at least one member of the joint monitoring group is scheduled to operate in a monitoring mode as per the monitoring schedule; and
coordinate one or more monitoring functions of the device and the at least one neighboring AP based on the monitoring schedule.

19. The device of claim 18, wherein the resource management logic is further configured to transmit the indication via a management frame.

20. A method, comprising:
selecting at least a first access point (AP) and a second AP as members of a joint monitoring group;
determining a monitoring schedule for the first AP and the second AP, wherein at least one member of the joint monitoring group is scheduled to operate in a monitoring mode as per the monitoring schedule; and
coordinating one or more monitoring functions of the first AP and the second AP based on the monitoring schedule.
